(19) United States
(12) Patent Application Publication
(10) Pub. No.: US 2007/0263847 A1
(43) Pub. Date: Nov. 15, 2007

(54) Environmental noise reduction and cancellation for a cellular telephone communication device

(76) Inventor: Alon Konchitsky, Cupertino, CA (US)

Correspondence Address: PERKINS COIE LLP, P.O. BOX 2168, MENLO PARK, CA, 94026, US

(21) Appl. No.: 11/402,459

(22) Filed: Apr. 11, 2006

(51) Int. Cl. H04M 1/00; H04M 9/00

(52) U.S. Cl. 379/392.01

(57) ABSTRACT

A system and method for reducing or entirely canceling background or environmental noise from a voice transmission from a communications device. A communications device, such as a cellular telephone or cordless telephone, is configured with an environmental noise counterbalanced (correction) signal generator that is connected between a microphone and a continuous time quadrant multiplication. The original output of the microphone and a counterbalanced (correction) signal generated by the environmental noise counterbalanced (correction) signal generator are mixed or combined together prior to being passed to a transmitter. In one embodiment a discrete time unit (discrete time processing) block with or without signal processing is provided between the microphone and the continuous time quadrant multiplication to help synchronize the timing of the signals to be mixed. In another embodiment a second microphone is employed to detect environmental noise.

### BACKGROUND

1. Field of the Invention

The present invention relates generally to voice communication systems, devices, telephones, and methods, and more specifically, to systems, devices, and methods that automate control in order to correct for variable environmental noise levels and reduce or cancel the environmental noise prior to sending the voice communication over cellular telephone communication links.

2. Background of the Invention

Voice communication devices such as cellular telephones and wireless telephones and communications devices other than cellular telephones have become ubiquitous; they show up in almost every environment. These systems and devices and their associated communication methods are referred to by a variety of names, such as but not limited to, cellular telephones, cell phones, mobile phones, wireless telephones in the home and the office, and devices such as personal data assistants (PDAs) that include a wireless or cellular telephone communication capability. They are used in the home, at the office, in the car, on a train, at the airport, at the beach, at restaurants and bars, on the street, and almost any other imaginable venue. As might be expected, these diverse environments have relatively higher and lower levels of background, ambient, or environmental noise. For example, there is generally less noise in a quiet home than there is in a crowded bar. And, this noise is picked up by the microphone of the communications device and if at sufficient levels, degrades the intended voice communication and though possibly not known to the user of the communications device, uses up more bandwidth or network capacity than is necessary, especially during non-speech segments of the two-way conversation when a user is not speaking at his or her telephone.

A cellular network is a radio network made up of a number of radio cells (or just cells) each served by a fixed transmitter, normally known as a base station. These cells are used to cover different geographical areas in order to provide radio coverage over a wider geographical area than the area of one cell. Cellular networks are inherently asymmetric with a set of fixed main transceivers each serving a cell and a set of distributed (generally, but not always, mobile) transceivers which provide services to the network's users.

The primary requirement for a cellular network is that the each of the distributed stations need to distinguish signals from their own transmitter from the signals from other transmitters. There are two common solutions to this requirement, frequency division multiple access (FDMA) and code division multiple access (CDMA). FDMA works by using a different frequency for each neighboring cell. By tuning to the frequency of a chosen cell, the distributed stations can avoid the signal from other neighbors. The principle of CDMA is more complex, but achieves the same result; the distributed transceivers can select one cell and listen to it. Other available methods of multiplexing such as polarization division multiple access (PDMA) and time division multiple access (TDMA) cannot be used to separate signals from one cell to the next since the effects of both vary with position, making signal separation practically impossible. Orthogonal frequency division multiplex (OFDM) in principal, consists of frequencies orthogonal to each other. Time division multiple access, however, is used in combination with either FDMA or CDMA in a number of systems to give multiple channels within the coverage area of a single cell.

In the case of a typical taxi company, each radio has a selector knob or button. The knob or button acts as a channel selector and allows the radio to tune to different frequencies. As the drivers and their vehicles move around, they change from channel to channel. The drivers know which frequency covers approximately what area, when they don't get a signal from the previously selected transmitter, they may typically also try other channels until they find one which works or on which they are able to receive or monitor communications in their local area. Usually, the taxi drivers only speak one at a time, as invited by the operator or according to voice traffic on the channel, in a sense time division multiplexed system.

The wireless world comprises the following exemplary, but not limited communication schemes: time based and code based. In the cellular mobile environment these techniques are named under TDMA (time division multiple access) which comprises but not limited to the following standards GSM, GPRS, EDGE, IS-136, PDC, and the like; and CDMA (code division multiple access) which comprises but not limited to the following standards: CDMA one, IS-95A, IS-95B, CDMA 2000, CDMA 1×EvDv, CDMA 1×EvDo, WCDMA, UMTS, TD-CDMA, TD-SCDMA, OFDM, WiMax, WiFi, and others).

For the code division based standards or orthogonal frequency division, as the number of subscribers grows and average minutes per month increase, more and more mobile calls typically originate and terminate in noisy environments. The background or ambient noise degrades voice quality.

For the time based schemes, like GSM or GPRS or Edge schemes, improving the end-user voice signal-to-noise ratio (SNR), improves the listening experience for users of existing TDMA (time division multiple access) based networks, by improving the received speech quality by employing background noise reduction or cancellation at the sending or transmitting device.

Significantly, in an on-going cellular telephone call or other communication from an environment having relatively higher environmental noise, it is sometimes difficult for the party at the other end of the connection to hear what the party in the noisy environment is saying. That is, the ambient or environmental noise in the environment often “drowns out” the cellular telephone user's voice, whereby the other party cannot hear what is being said or even if they can hear it with sufficient volume the voice or speech is not understandable. This problem may even exist in spite of the conversation using a high data rate on the communications network.

Attempts to solve this problem have largely been unsuccessful. Both single microphone and two microphone approaches have been attempted. For example, U.S. Pat. No. 6,415,034 (the “Hietanen patent”) describes the use of a second background noise microphone located within an earphone unit or behind an ear capsule. Digital signal processing is used to create a noise canceling signal which enters the speech microphone. Unfortunately, the effectiveness of the method disclosed in the Hietanen patent is compromised by acoustical leakage, that is where ambient or environmental noise leaks past the ear capsule and into the speech microphone. The Hietanen patent also relies upon complex and power consuming expensive digital circuitry that may generally not be suitable for small portable battery powered devices such as pocketable cellular telephones. Another example is U.S. Pat. No. 5,969,838 (the “Paritsky patent”) which discloses a noise reduction system utilizing two fiber optic microphones that are placed side-by-side next to one another. Unfortunately, the Paritsky patent discloses a system using light guides and other relatively expensive and/or fragile components not suitable for the rigors of cell phones and other mobile devices. Neither Paritsky nor Hietanen address the need to increase capacity in cellular telephone-based communication systems.

Therefore, there is a need in the art for a method of noise reduction or cancellation that is robust, suitable for mobile use, and inexpensive to manufacture. The increased traffic in cellular telephone based communication systems has created a need in the art for means to increase signal to noise ratios in communication devices.

### SUMMARY

The present invention provides a novel system and method for monitoring the noise in the environment in which a cellular telephone is operating and canceling the environmental noise before the environmental noise is transmitted to the other party so that the party at the other end of the voice communication link can more easily hear what the cellular telephone user is transmitting.

The present invention preferably employs noise reduction and or cancellation technology that is operable to attenuate or even eliminate pre-selected portions of an audio spectrum. By monitoring the ambient or environmental noise in the location in which the cellular telephone is operating and applying noise reduction and/or cancellation protocols at the appropriate time, it is possible to significantly reduce the ambient or background noise to which a party to a cellular telephone call might be subjected.

In one aspect of the invention, the invention provides a system and method that enhances the convenience of using a cellular telephone or other wireless telephone or communications device, even in a location having relatively loud ambient or environmental noise.

In another aspect of the invention, the invention provides a system and method for canceling ambient or environmental noise before the ambient or environmental noise is transmitted to another party.

In yet another aspect of the invention, the invention monitors ambient or environmental noise via a second microphone associated with a cellular telephone, that is different from a first microphone that is primarily responsible for collecting the speakers voice, and thereafter cancel the monitored environmental noise.

In still another aspect of the invention, the invention optionally provides an enable/disable switch on a cellular telephone device to enable/disable the noise reduction and or cancellation features of the invention.

In yet another aspect, the invention provides a communications device, comprising: a first microphone having a microphone output providing a first signal containing both voice and environmental noise; a second microphone having a microphone output providing a second signal containing substantially only environmental noise; an environmental noise counterbalanced (correction) signal generator having: (i) an environmental noise counterbalanced (correction) signal generator input connected to both the first microphone output and the second microphone output, and (ii) an environmental noise counterbalanced (correction) signal generator output; a continuous time quadrant multiplication having: (i) a first multiplication input in communication with the first microphone output, and (ii) a second multiplication input connected to the environmental noise counterbalanced (correction) signal generator output, and (iii) a multiplication output; and a transmitter having a transmitter input connected to the multiplication output and a transmitter output in communication with an antenna; wherein environmental noise picked up by the first microphone and by the second microphone is processed by the environmental noise counterbalanced (correction) signal generator and wherein the environmental noise is attenuated before being passed to the transmitter.

In still another aspect, the invention provides a noise processing apparatus for use in a communications device, noise processing apparatus comprising: a first input port for receiving at least one electrical signal from a first microphone transducer adapted to detect and transducer an acoustic sound wave containing both voice and environmental noise information; an environmental noise counterbalanced (correction) signal generator coupled to the first input port and generating a correction signal output at an output port; a continuous time quadrant multiplier having (i) a first multiplication input for receiving the at least one electrical signal from a first microphone transducer, and (ii) a second multiplication input for receiving the correction signal, and generating (iii) a multiplication output that is the noise reduced or cancelled voice signal; and wherein environmental noise picked up by the first microphone is processed by the environmental noise counterbalanced (correction) signal generator and wherein the environmental noise is attenuated before being passed to a transmitter.

In still another aspect, the invention provides a method for canceling noise in a communications device comprising: detecting an original combined voice acoustic signal and noise acoustic signal at a first transducer and generating a first electrical signal representing the combined voice and noise signal detected at the first transducer; processing the first original combined voice and noise signal to generate a noise correction signal; and applying the noise correction signal and the first original combined voice and noise signal to generate an enhanced voice and noise signal wherein a noise component of the enhanced voice and noise signal is substantially reduced and the signal-to-noise ratio of the voice component is improved.

These and other aspects of the present invention will become apparent upon reading the following detailed description in conjunction with the associated drawings.

### BRIEF DESCRIPTION OF THE DRAWINGS

FIG. 1 illustrates an exemplary cellular telephone including first microphone primarily to detect the user's voice and an optional second microphone for sampling environmental noise and an enable/disable button in accordance with an embodiment the present invention.

FIG. 2 illustrates an exemplary embodiment of the present invention having a single microphone and noise reduction and cancellation processing.

FIG. 3 illustrates a second exemplary embodiment of the present invention having two microphones and noise reduction and cancellation processing.

FIG. 4 illustrates a typical exemplary communications device, here an exemplary cellular telephone, and its microphone input to an analog base-band and/or voice-band codec.

FIG. 5 illustrates an exemplary embodiment of a communications device, here an exemplary cellular telephone, incorporating a first embodiment of the inventive noise reduction and cancellation processing unit that uses a single microphone input.

FIG. 6 illustrates another exemplary embodiment of a communications device, here an exemplary cellular telephone, incorporating a second embodiment of the inventive noise reduction and cancellation processing unit that uses two microphone inputs.

FIG. 7 illustrates an exemplary voice with noise signals and the reduction of the noise to a noise floor that can be achieved using the inventive noise reduction and cancellation processing.

FIG. 8 illustrates an exemplary second set of experimental results showing: (a) a clean voice signal without noise, (b) a voice signal with environmental noise, and (c) the voice signal in (b) after being enhanced by removal and cancellation of the noise using an embodiment of the invention.

FIG. 9 illustrates an exemplary third set of experimental results showing: (a) a clean voice signal without noise, (b) a voice signal with environmental noise, and (c) the voice signal in (b) after being enhanced by removal and cancellation of the noise using an embodiment of the invention.

FIG. 10 illustrates an exemplary first set of experimental results showing: (a) a clean voice signal without noise, (b) a voice signal with environmental noise, and (c) the voice signal in (b) after being enhanced by removal and cancellation of the noise using an embodiment of the invention.

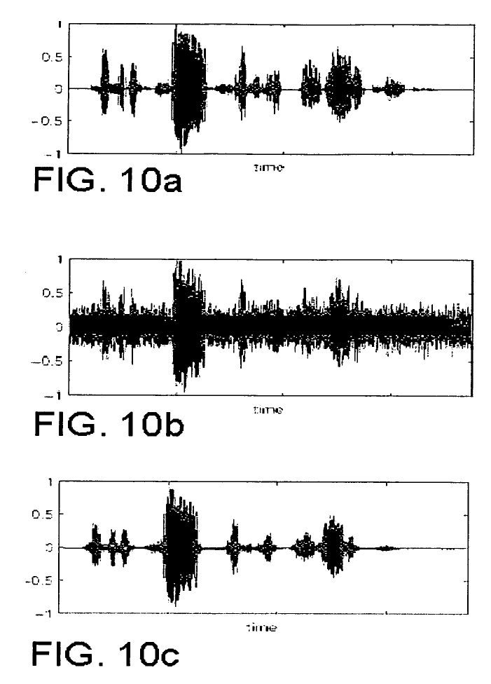

### DETAILED DESCRIPTION OF EMBODIMENTS OF THE INVENTION

The present invention provides a novel and unique background noise or environmental noise reduction and/or cancellation feature for a communications device such as a cellular telephone, wireless telephone, cordless telephone, recording device, wireless headset, and other communications and/or recording devices. While the present invention has applicability to at least these types of communications devices, the principles of the present invention are particularly applicable to all types of communications devices, as well as other devices that process or record speech in noisy environments such as voice recorders, dictation systems, voice command and control systems, and the like. For simplicity, the following description employs the term “telephone” or “cellular telephone” as an umbrella term to describe the embodiments of the present invention, but those skilled in the art will appreciate that the use of such term is not to be considered limiting to the scope of the invention, which is set forth by the claims appearing at the end of this description.

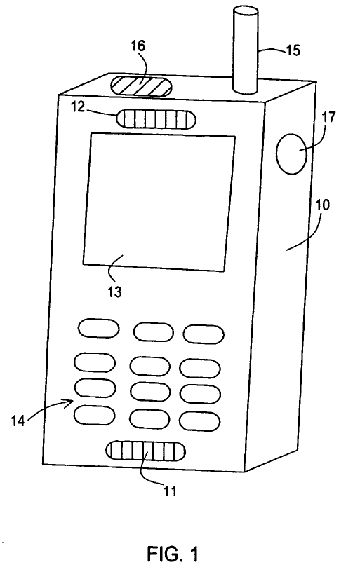

FIG. 1 illustrates an exemplary cellular telephone 10 that comprises a first microphone 11, a speaker 12, a display screen 13, a keypad 14, an antenna 15, and a housing 18 having an outer surface 19. Optionally, a second microphone 16 for either continuous time or discrete time sampling environmental noise level and an environmental noise counterbalanced (correction) enable/disable button 17 may also be provided. The enable/disable button or feature 17 may be exposed on the surface of the housing or be available through a menu drive options or telephone set up procedure. These second microphone 16 and enable/disable button or feature 17 will be described more fully below. Those skilled in the art will appreciate that speaker 12 could be replaced by an ear piece, head-set, or other electrical signal to acoustic transducer (not shown) that is worn by the cellular telephone user in the conventional manner. Speaker 12 is used herein to mean the device by which sound (such as in the form of an acoustic pressure wave) is transferred from the cellular telephone (typically in the form of a digital or electrical signal) to the user. Also, display screen 13 could be a touch screen display, which might incorporate keypad 14 as well as enable/disable button 17. Various other different interfaces my be utilized as are known in the art.

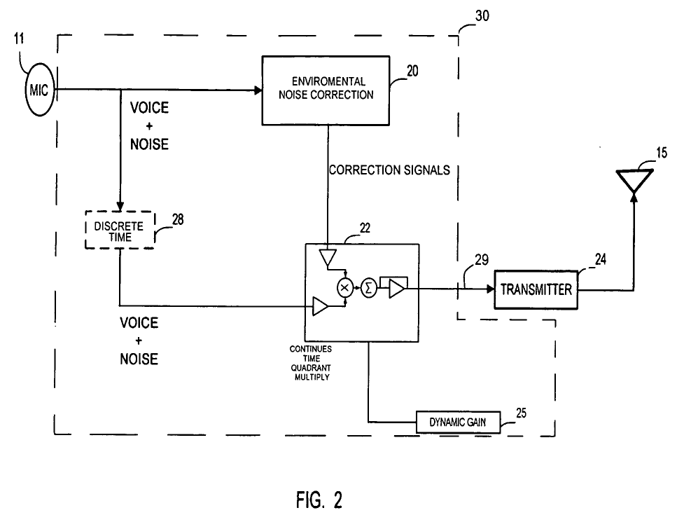

FIG. 2 illustrates an exemplary embodiment of the noise reduction and cancellation (NRC) block 30 of present invention coupled to microphone (MIC) 11 and transmitter 24 which itself is coupled to antenna 15 when present. In one embodiment of the invention, the microphone 11 is the microphone of a standard telephone or communication device and the transmitter is or represents the other circuitry and/or logic in the analog baseband and audio sections (or other mixed signal blocks) of the telephone or device as well as any other downstream processing to the antenna (when present). In other embodiments of the invention, the invention itself includes the microphone 11, noise reduction or cancellation block 30, and the other portions of the telephone or communication device.

Noise reduction or cancellation block 30 includes an environmental noise counterbalanced (correction) signal generator 20 that generates correction signals 21, and a continuous time quadrant multiplier 22 or other processing circuit for receiving the voice+noise signal and a noise correction signal and removing the noise from the voice+noise signal. A dynamic gain circuit or logic block 25 may optionally be employed to modify a weight, gain, or amplification of one of more of the signals in the continuous time quadrant multiplier 22. This modification of the dynamic gain may be used to adjust the amount or gain of the noise cancellation or could be turned off or shut down if and when desired. A static or fixed gain may alternatively be utilized but is not preferred. In some instances, the gain applied may be positive (e.g., amplification), negative (e.g., attenuation), or unity gain (e.g., gain is unity or no gain, amplification, or attenuation). The gain applied to each of the possible inputs may be independently selected. Typically at least one of the gains will be a non-unity gain at least at selected times of operation.

In accordance with one aspect of the present invention, environmental noise or background noise is attenuated, reduced, or cancelled from the intended voice communication picked up at microphone 11 and sent to transmitter 24 and antenna 15. It will be appreciated that a theoretical goal is to cancel all ambient or environmental voice and to attenuate none of the speech signal, however, in practice it is inevitable that some environmental noise may remain and/or that some speech signal may be attenuated. Therefore, it will be understood that references to canceling noise refer to reduction of noise with the goal of eliminating the noise.

More specifically, in a first embodiment, microphone 11 picks up both environmental noise as well as the intended voice communication (together, the voice+noise or “combined signal”). As is well known in the art of noise reduction and/or noise cancellation, it is possible (e.g., via filtering and digital signal processing techniques) to attenuate or even cancel-out pre-selected portions of an audio signal or pre-selected bands of a frequency spectrum. These techniques may however in some instances be limited to noise that is somewhat predictable, or periodic, such as a vibrational frequency or set of frequencies of an engine or motor.

As shown in FIG. 2, environmental noise counterbalanced (correction) signal generator 20 is connected to microphone 11 and detects and otherwise monitors the combined signal. It is noted that in this single microphone embodiment, the electrical output signal representing the combined voice and noise signal is communicated to both the environmental noise correction unit 20 and to the continuous time quadrant multiply unit 22 (optionally through the discrete time 28 processing unit). Then, environmental noise reduction and or cancellation generator, in accordance with well-known techniques, generates counterbalanced (correction) signals that are operable to attenuate or altogether cancel background noise that is not intended or desirable to be transmitted to another party.

For example, the environmental noise reduction and or cancellation generator may generate cancellation or correction signals according to the techniques described in U.S. Pat. No. 6,968,171 (Vanderhelm et al) directed to an Adaptive Noise Reduction System For A Wireless Receiver, which is hereby incorporated by reference herein.

These counterbalanced (correction) signals are fed into continuous time quadrant multiplication 22 where these signals are mixed or combined with the combined signal coming from microphone 11. Various techniques for adding and subtracting or otherwise combining two signals are know in the art, such as the use of operational amplifiers, differential amplifiers, comparators, and the like circuits, and these techniques and circuits may be utilized here. The result is that the environmental noise or background noise is eliminated or cancelled, or at least substantially reduced, before the noise reduced combined signal 29 (environmental noise plus voice signal) is passed to transmitter 24 (which, e.g., includes a radio frequency modulator, and the like components required for the operation of the wired or wireless device) and ultimately to antenna 15 (when present).

In one embodiment, the continuous time quadrant multiplier 22, two single ended inputs (or optionally differential inputs) receive a first signal including the voice+noise signal and a second signal including the noise only signal without the voice component, and are followed by voltage-to-current conversion circuits that generate voice+noise and noise only signals suitable for input to the continuous time multiplier circuit. The product of these two signals is generated by a continuous time multiplier circuit, followed by a sum circuit that could accept a gain or dynamic gain to increase (amplify) or decrease (attenuate) the output level for the signal cleaned from noise. This cleaned signal is referred to as the enhanced signal in some of the result data described hereinafter in this description. It will be appreciated that where amplification or gain are described in decibels or db, which are logarithmic units, multiplication in non-logarithmic terms becomes a summation in logarithmic terms.

The dynamic gain circuit or logic block 25 may optionally be employed to modify a weight, gain, or amplification of one of more of the signals in the continuous time quadrant multiplier 22. This way, better noise cancellation is achieved, and a cleaner output is presented. Although not specifically illustration in the drawings to avoid obscuring the more significant features of the embodiments, it should be appreciated that the gain or dynamic gain input may be applied to the noise reduction and cancellation processor 30, 32 in any one or combination of several ways and is therefore shown as an input to the processing block as a whole. The gain whether fixed, variable, adjustable, or dynamic may be applied to either or both of the voice+noise or noise only inputs (either before of after the voltage-to-current conversion), to the output of the continuous time multiplier only or in combination with application to one or both of the inputs. Embodiments of the invention may also provide for gains of different value to be applied to any one or combination of these signals or components processing the signals so that appropriately weighted gains may be applied to the different signals to achieve the desired processing result.

Optionally, a discrete time unit (discrete time processing) block with or without signal processing 28 may be provided to slow or controllably delay the progress or propagation of the electrical combined signal emanating from the output of the microphone 11 so that when the combined signal reaches the continuous time quadrant multiplication 22 the arrival time of the combined signal and the counterbalanced (correction) signal(s) generated by environmental noise reduction and or cancellation generator is synchronized. Alternatively or additionally, the timing of the counterbalanced (correction) signals generated by environmental noise reduction and or cancellation generator may be delayed or controlled so that synchronization is achieved.

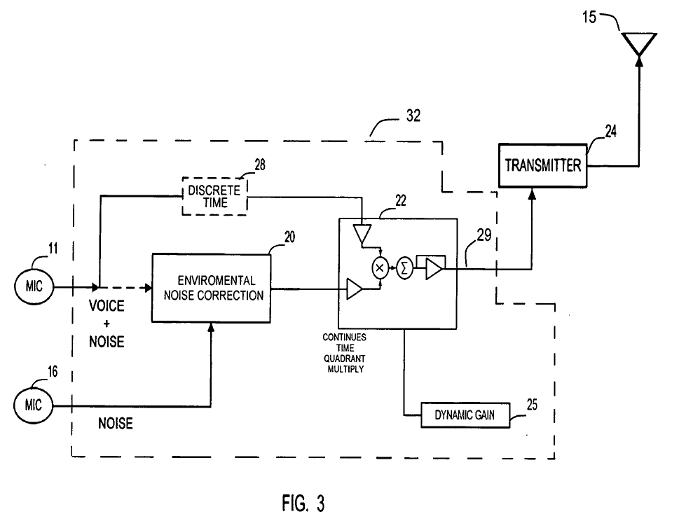

In another embodiment of an alternative noise reduction and cancellation (NRC) block 32 of present invention, as shown in FIG. 3, a second microphone 16 is provided (in addition to first microphone 11) for the principal purpose of sampling or detecting the ambient or environmental noise other than the speaker's voice. That is, microphone 16 is dedicated substantially to picking up environmental noise rather than a voice signal. A second microphone 16, especially one that is located away from the cellular telephone user's mouth where the acoustic sound wave pressure of the voice is lower that it would at or near the mouth would be less affected by the user's own voice when taking the environmental noise level measurement and, thus, might be more desirable in certain implementations of the present invention. The other elements illustrated in FIG. 3 that are the same as in FIG. 2 have the analogous functions as those already described and are not repeated here.

More specifically, it is often the case that first microphone 11, which is used primarily for receiving voice signals from a user, is arranged to have directional characteristics, wherein the microphone is more sensitive to sound waves coming from predetermined directions such as for example, directly toward the microphone. In contrast, second microphone 16 is preferably omni-directional such that the second microphone is equally sensitive to sound emanating from any direction. A more accurate detection of environmental noise level may be obtained using such an omni-directional microphone. Also, although not shown expressly in the drawings, microphone 16 could be arranged spatially distant from the cellular telephone 10. For example, second microphone 16 could be arranged to hang from a wire that is connected to cellular telephone 10, whereby there would be even less chance for the cellular telephone user's voice to interfere with noise reduction and or cancellation signal generation.

As with the embodiment of the invention described relative to FIG. 2, this embodiment may optionally include a discrete time unit (discrete time processing) block with or without signal processing 28 to slow or controllably delay the progress or propagation of the electrical combined signal emanating from the output of microphone 11 and/or microphone 16 so that when the combined signal reaches the continuous time quadrant multiplication 22 the arrival time of the combined signal and the counterbalanced (correction) signal(s) generated by environmental noise reduction and or cancellation generator is synchronized. Alternatively or additionally, the timing of the counterbalanced (correction) signals generated by environmental noise reduction and or cancellation generator may be delayed or controlled so that synchronization is achieved.

Optionally, in the dual microphone embodiment, first microphone 11 as well as second microphone 16 is also in communication with environmental noise reduction and or cancellation signal generator 20 to provide additional signal information to generator 20 to aid in distinguishing more easily between environmental noise and voice signals.

Further in accordance with the present invention there is optionally provided an enable/disable switch 17 (FIG. 1) that is preferably operable to enable/disable environmental noise counterbalanced (correction) signal generator 20. For example, depending on the nature of the environmental noise in a particular environment, known noise reduction and or cancellation techniques might also inadvertently attenuate the voice signal that is intended to be transmitted. In such a case, it is preferable that the noise reduction and or cancellation features of the present invention be disabled, at least for a limited period, until the environmental noise is such that it can be more effectively distinguished from the voice signal and attenuated independently. For example, a cellular telephone user may want to call a friend from a noisy public event (e.g., a concert or sporting event) for the main purpose of letting the friend hear the background noise of the crowd. In such a case, the switch 17 is preferably manipulated to disable the noise reduction and or cancellation features of the present invention.

Having now described aspects of first and second embodiments of the inventive noise reduction and cancellation processing block 30, 32 relative to microphones and the other components of the communications device such as a cellular telephone, we now describe the relationship of these processing blocks 30 or 32 relative to a conventional cellular telephone architecture to illustrate the relationship between the inventive processing block and the analog baseband/voiceband CODEC or other stage of a communications device that normally receives the electrical signal output by the microphone.

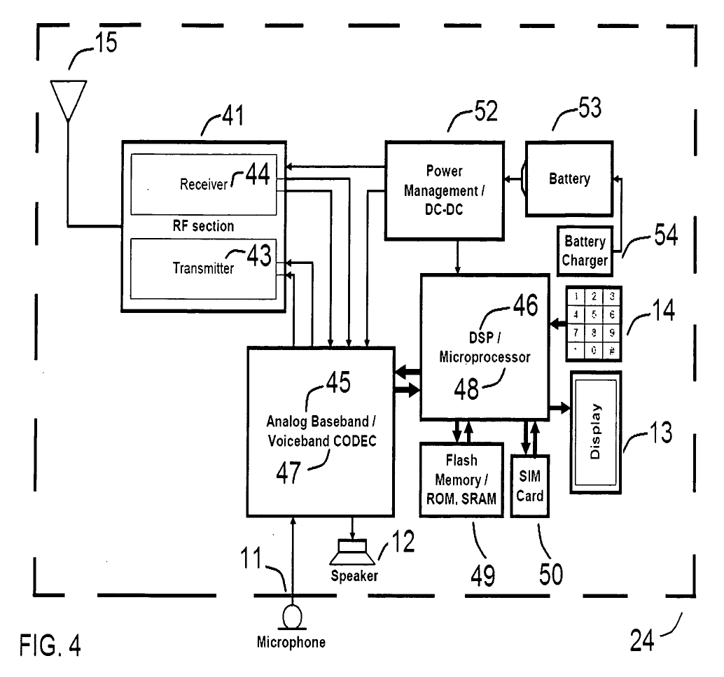

FIG. 4 illustrates a block diagram typical of the major functional blocks of a cellular telephone of the type not having the noise reduction and cancellation processing of the invention. This architecture is described so that the manner in which the invention interoperates with and improves the performance may be better understood.

Radio Frequency or RF section 41 includes a transmit section 42 and a receive section 43 and is where the RF signal is filtered and down-converted to analog baseband signals for the receive signal. It is also where analog baseband signals are filtered and then up-converted and amplified to RF for the transmit signal. Analog Baseband 45 is where analog baseband signals from RF receiver section 44 are filtered, sampled, and digitized before being fed to the Digital Signal Processing (DSP) section 46. It is also where coded speech digital information from the DSP section are sampled and converted to analog baseband signals which are then fed to the RF transmitter section 43. It will be understood that no radio-frequency (RF) section or antenna would be required for a wired line implementation.

The Voiceband Codec (VoCoder) 47 is where voice speech from the microphone 11 is digitized and coded to a certain bit rate (for example, 13 kbps for GSM) using the appropriate coding scheme (balance between perceived quality of the compressed speech and the overall cellular system capacity and cost). It is also where the received voice call binary information are decoded and converted in the speaker or speakerphone 48.

The digital signal processor (DSP) 46 is a highly customized processor designed to perform signal-manipulation calculations at high speed. The microprocessor 48 handles all of the housekeeping chores for the keyboard and display, deals with command and control signaling with the base station and also coordinates the rest of the functions on the board.

The ROM, SRAM, and Flash memory chips 49 provide storage for the phone's operating system and customizable features, such as the phone directory. The SIM card 50 belongs to this category, it stores the subscriber's identification number and other network information.

Power Management/DC-DC converter section 52 regulates from the battery 53 all the voltages required to the different phone sections. Battery charger 54 is responsible for charging the battery and maintaining it in a charged state.

Keypad 55 and display 13 provide an interface between a user and the internal components and operational features of the telephone.

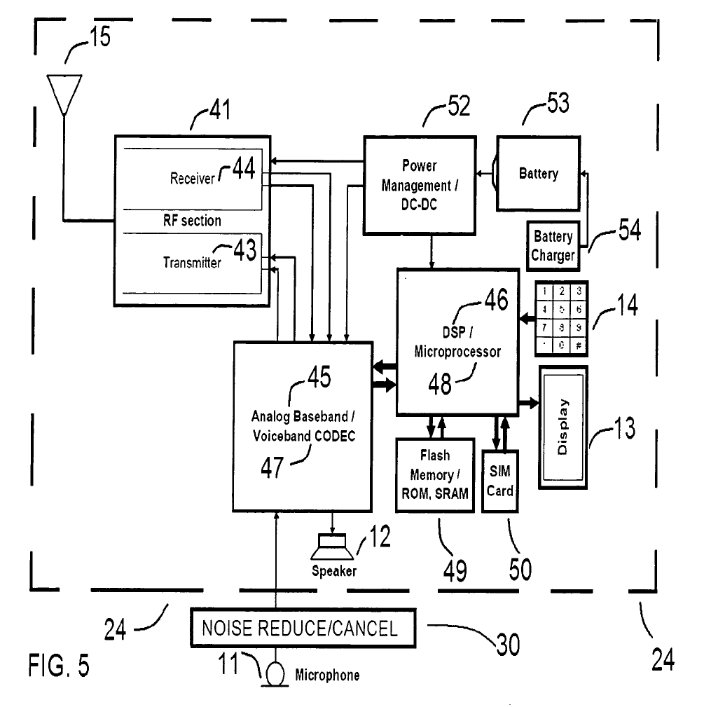

FIG. 5 is an illustration showing the relationship between the first embodiment of the inventive noise reduction processing block 30, the single microphone 11, and the remainder of the exemplary cellular telephone 40. It will be apparent to those workers skilled in the art that the inventive noise reduction and cancellation block is interposed or coupled between the single microphone 11 of the telephone in its conventional configuration and the analog baseband/voiceband CODEC of the conventional telephone. In fact the output of the noise reduction processing block 30 may be seen to be a processed version of the original microphone input and may connect at the same microphone input port as in a conventional phone. Not shown in the drawing is a possible connection between the noise reduction processing block 30 and the battery 53 (or the power management block 52 (depending upon implementation) that might be needed for a cellular telephone, but may not generally be needed for a wire lined device. The noise reduction processing block 30 may optionally rely on a separate power source such as an auxiliary battery that only powers the noise reduction processing block 30. It will also be appreciated that a wire lined device would not require a battery or battery charger and would receive electrical power (voltage and current) from other electrical supply sources within the device.

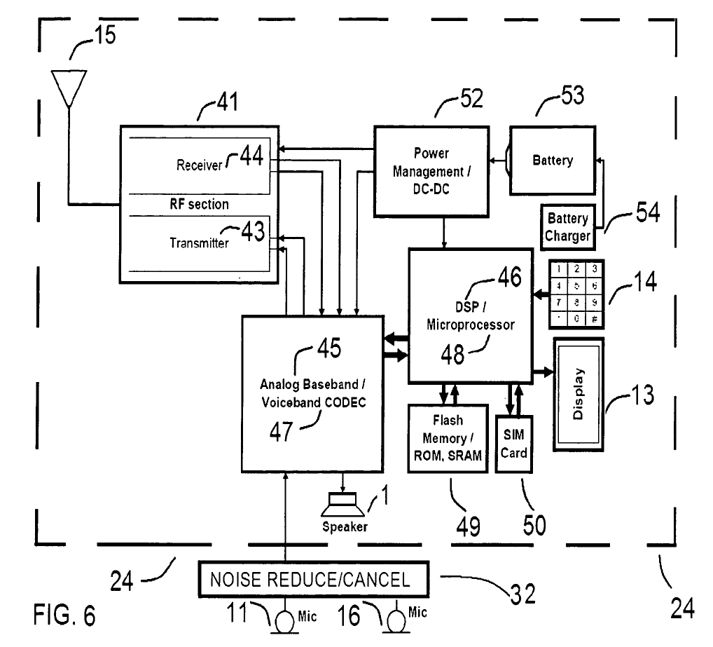

FIG. 6 is an illustration showing the relationship between the second embodiment of the inventive noise reduction processing block 32, the first and second microphones 11, 16 and the remainder of the exemplary cellular telephone 40. Again, it will be apparent to those workers skilled in the art that the inventive noise reduction and cancellation block is interposed or coupled between the first microphone 11 and the second microphone 16 of the telephone and the analog baseband/voiceband CODEC of the conventional telephone. It will be apparent in this embodiment that even though there are two microphones, there is still only one noise reduced signal output from the noise reduction and cancellation processor 32 to the input of the analog baseband/voiceband CODEC so that no modification is required. Again, the output of the noise reduction processing block 32 may be seen to be a processed version of the original dual microphone input and may connect at the same microphone input port as in a conventional telephone. As in FIG. 5, not shown in the drawing is a possible connection between the noise reduction processing block 32 and the battery 53 (or the power management block 52 (depending upon implementation). The noise reduction processing block 32 may optionally rely on a separate power source such as an auxiliary battery that only powers the noise reduction processing block 32.

### EXEMPLARY EXPERIMENTAL RESULTS

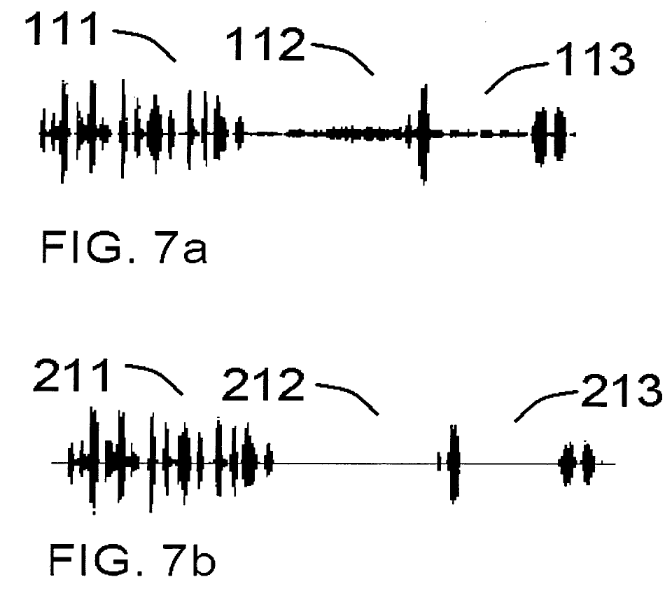

Attention is now directed to some exemplary experimental results that show the significant reduction of noise and indeed cancellation or virtual cancellation of the noise component of the input voice+noise signal. A general explanation relative to FIG. 7 is first provided, followed by specific results.

As discussed elsewhere herein, except for well behaved and understood types of noise, it may generally not be possible to completely reduce the noise to a level that it is precisely cancelled with no residual component at any frequency or time, particularly if the signal is to be passed more or less without degradation. On the other hand, it is possible to reduce the level of noise to the point where it is virtually cancelled so that substantially all of the noise that an ordinary user would hear or that would tend to mask or degrade the quality of a conversation over a telephone or other communication device can be removed or cancelled. The structures, circuits, systems, and methods described herein substantially reduce and effectively cancel the noise component and noise is reduced down to the level that it is effectively cancelled and for some types of noise actually cancelled.

FIG. 7(a) is an illustration showing a signal with noise. Even during time intervals where there is no speech or voice signal, there is a noise signal present, that will or may trigger higher sampling and transmission rates. A listener at the other end of the conversation may even be unsure if someone is speaking during these intervals if the noise is severe and the voice signal of low amplitude or volume. The noise is also present during the higher amplitude portions of the signal and make speaker difficult to hear or to understand if the signal-to-noise ratio is too low. In this figure, various portions of a typical voice or speech signal are illustrated, with the higher amplitude portions of the voice signal with noise 111, and the noise in a noisy environment 112 and exhibiting nose characteristics that are more stationary or white noise 113.

FIG. 7(b) is an illustration showing the improvement is voice signal quality and the reduction of noise during periods of non-speech when the signal should theoretically have no amplitude. In fact the inventive system, device, method, provide such reduction to the point where the noise that had been mixed with the voice signal is removed. In this figure, the various portions of the typical voice or speech signal are illustrated after being enhanced by the noise reduction or cancellation, with the higher amplitude portions of the voice signal with noise 21 1, and the noise in a noisy environment 212 and exhibiting noise characteristics that are more stationary or white noise 213. Notice that the noise portions 212, 213 have been cancelled and the remaining thin horizontal line being the time axis and not an actual noise amplitude. With the inventive noise cancellation the noise has been reduced to level where it is disappeared to the physics limitation and both the environment noise and the stationary white noise components have been reduced to the noise floor. As described elsewhere in this application, this reduction and cancellation of noise during the speech portion significantly improves received voice quality with no penalty and with very little added power consumption. Furthermore, the reduction and effective cancellation of the noise during periods of non-speech permit significant reduction of data rate switching, permit operation at an overall lower data rate, and provide for an opportunity to increase network capacity without adding additional infrastructure and without degrading the transmit-receive quality of the existing network subscribers and users.

Tests on prototypes of a embodiments of the invention having microphones both one and two microphone inputs and using the continuous time analog processor with and without the optional discrete processor were performed using three different sets of noise conditions. These results are summarized in Table I. All results are normalized to a 0 db SNR before processing so that the recited SNR improvements are relative to the normalized values. Not all combinations were tested. In general, the present invention with single microphone achieves about 3 dB improvement when using continuous time processing, and about 2.5 dB improvement when using discrete time processing. The dual-microphone embodiments realized about 3.5 dB improvement with the continuous time block processing relative to the result produced with the single microphone; a 5.5 dB improvement over the single microphone embodiment when both continuous time (e.g., analog) processing and discrete time processing were both used, and about a 2.5 dB improvement in SNR when used only with the continuous time processing. Up to 13.5 dB in SNR improvement of voice relative to noise was achieved when utilizing embodiments of the invention with two microphones and both continuous time and discrete time processing.

TABLE I
Experimental Data for Selected Prototypes
of the Embodiments of the Invention

| | SNR Improvement for | SNR Improvement for |
|---|---|---|
| Noise Condition | Single-Microphone | Dual-Microphone |
| general ambient | 9.9 dB | — |
| noise | (analog & discrete time proc.) | |
| white stationary | 7.6 dB | 10.1 dB |
| noise | (analog & discrete time proc.) | (analog proc.) |

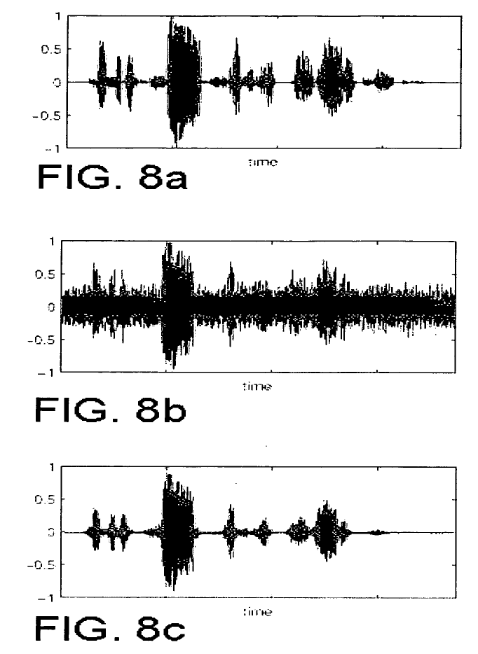

In the first set of conditions, the noise component was again white stationary noise and an SNR improvement of about 7.6 dB was achieved using a single microphone and both continuous time (e. g., analog) processing and the optional discrete time processor. The time versus amplitude waveforms for this set of conditions are illustrated in FIG. 8(a-c), where there is shown: (a) clean temporal speech waveform in a substantially noise free environment, (b) the noisy temporal speech waveform for the noisy (speech+noise) environment, and (c) the enhanced or noise reduced and cancelled temporal speech waveform processed with the inventive apparatus and method. It is apparent from a comparison of the clean speech waveform in (a) and the enhanced noise reduced and cancelled waveform in (c) that the inventive apparatus and method have been very effective in reducing and canceling noise while still maintaining the fidelity of the original speech.

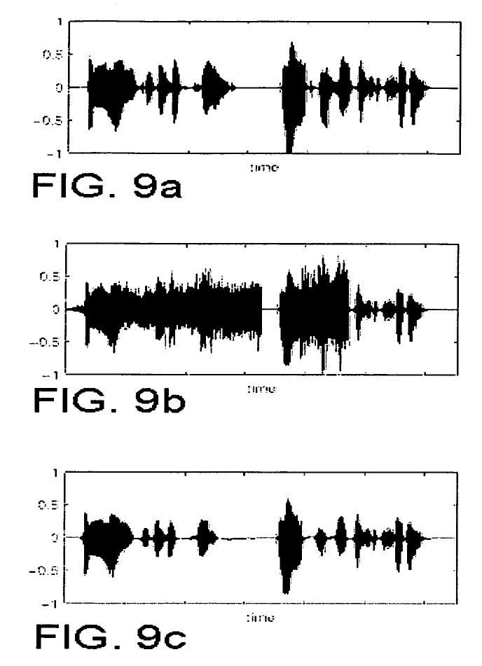

In the second set of conditions, the noise component was general ambient noise and an SNR improvement of about 9.9 dB was achieved using a single microphone and both continuous time (e. g., analog) processing and the optional discrete time processor. The time versus amplitude waveforms for this set of conditions are illustrated in FIG. 9(a-c), where there is shown: (a) clean temporal speech waveform in a substantially noise free environment, (b) the noisy temporal speech waveform for the noisy (speech+noise) environment, and (c) the enhanced or noise reduced and cancelled temporal speech waveform processed with the inventive apparatus and method. It is again apparent from a comparison of the clean speech waveform in (a) and the enhanced noise reduced and cancelled waveform in (c) that the inventive apparatus and method have been very effective in reducing and canceling noise while still maintaining the fidelity of the original speech.

Finally in the third set of conditions, the noise component was white stationary noise and an SNR improvement of about 10.1 dB was achieved using a dual-microphone and only continuous time (e. g., analog) processing without the optional discrete time processor. The time versus amplitude waveforms for this set of conditions are illustrated in FIG. 9(a-c), where there is shown: (a) clean temporal speech waveform in a substantially noise free environment, (b) the noisy temporal speech waveform for the noisy (speech+noise) environment, and (c) the enhanced or noise reduced and cancelled temporal speech waveform processed with the inventive apparatus and method. Again, it is apparent from a comparison of the clean speech waveform in (a) and the enhanced noise reduced and cancelled waveform in (c) that the inventive apparatus and method have been very effective in reducing and canceling noise while still maintaining the fidelity of the original speech.

While not all combinations of noise type and processing scenarios have been tested or are presented herein, it has been observed that using two microphones rather than a single microphone with continuous time (analog) processing results in about 2 dB better performance than when using a single microphone, that using two microphones rather than a single microphone with discrete time processing only and no continuous time (analog) processing results in about 2.5 dB better performance than when using a single microphone, and that using two microphones rather than a single microphone with both continuous time (analog) processing and the optional discrete time processing results in about 6 dB better performance than when using a single microphone. Therefore it may be appreciated that the various embodiments of the invention may provide signal-to-noise improvements relative to non-noise reduced or cancelled situations of between about 5 dB and about 15 dB, while others may provide improvements of between 5 dB and 10 dB or more, and still others may provide improvements of between 10 dB and 15 dB or more, though even additional increases in SNR may be expected by additional tuning of components and processing parameters.

The implementation with specialized microphones having particular directional characteristics, frequency response characteristics, internal noise canceling characteristics, or other response or transducer characteristics may provide different or additional sound reduction or cancellation when combined with the invention.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

What is claimed is:

1. A telephone communications device, comprising:
a first microphone having a microphone output providing a first signal containing both voice and environmental noise;
a second microphone having a microphone output providing a second signal containing substantially only environmental noise;
an environmental noise counterbalanced (correction) signal generator having: (i) an environmental noise counterbalanced (correction) signal generator input connected to both the first microphone output and the second microphone output, and (ii) an environmental noise counterbalanced (correction) signal generator output;
a continuous time quadrant multiplication having: (i) a first multiplication input in communication with the first microphone output, and (ii) a second multiplication input connected to the environmental noise counterbalanced (correction) signal generator output, and (iii) a multiplication output;
the continuous time quadrant multiplier being adapted to receive a gain signal or value to provide an amplification or an attenuation of at least one of the first multiplication input signals, second multiplication input signals, and multiplication output signals from the continuous time quadrant multiplier; and
a transmitter having a transmitter input connected to the multiplication output and a transmitter output in communication with an antenna;
wherein environmental noise picked up by the first microphone and by the second microphone is processed by the environmental noise counterbalanced (correction) signal generator and wherein the environmental noise is attenuated before being passed to the transmitter.

2. The communications device of claim 1, wherein the communications device is a cellular telephone including a baseband processor adapted to receive a microphone voice signal input.

3. The communications device of claim 1, wherein the second microphone is spatially distant from the communications device.

4. The communications device of claim 1, further comprising a discrete time unit with or without memory or signal processing interposed between the first microphone and the continuous time quadrant multiplication.

5. The communications device of claim 1, further comprising an enable/disable switch for enabling/disabling the environmental noise counterbalanced (correction) signal generator.

6. A noise processing apparatus for use in a communications device, noise processing apparatus comprising:
a first input port for receiving at least one electrical signal from a first microphone transducer adapted to detect and transducer an acoustic sound wave containing both voice and environmental noise information;
an environmental noise counterbalanced (correction) signal generator coupled to the first input port and generating a correction signal output at an output port;
a continuous time quadrant multiplier having (i) a first multiplication input for receiving the at least one electrical signal from a first microphone transducer, and (ii) a second multiplication input for receiving the correction signal, and generating (iii) a multiplication output that is the noise reduced or cancelled voice signal; and
wherein environmental noise picked up by the first microphone is processed by the environmental noise counterbalanced (correction) signal generator and wherein the environmental noise is attenuated before being passed to a transmitter.

7. The noise processing apparatus of claim 6, further comprising a second input port for receiving at least one electrical signal from a second microphone transducer adapted to detect and transducer an acoustic sound wave containing primarily environmental noise information; and
the environmental noise counterbalanced (correction) signal generator coupled to the first input port to receive the first microphone input signal and to a second input port to receive the second microphone input signal, and generating a correction signal output at an output port.

8. The noise processing apparatus of claim 6, wherein the communications device comprises a cellular telephone.

9. The noise processing apparatus of claim 7, wherein the second microphone is spatially distant from the communications device.

10. The noise processing apparatus of claim 6, further comprising a discrete time unit with or without memory or signal processing interposed between the first microphone and the continuous time quadrant multiplication.

11. The noise processing apparatus of claim 6, further comprising an enable/disable switch for enabling/disabling the environmental noise counterbalanced (correction) signal generator.

12. A method for canceling noise in a cellular telephone communications device, the method comprising:
detecting an original combined voice acoustic signal and noise acoustic signal at a first transducer and generating a first electrical signal representing the combined voice and noise signal detected at the first transducer;
processing the first original combined voice and noise signal to generate a noise correction signal; and
applying the noise correction signal and the first original combined voice and noise signal to generate an enhanced voice and noise signal wherein a noise component of the enhanced voice and noise signal is substantially reduced and the signal-to-noise ratio of the voice component is improved.

13. The method in claim 12, further comprising:
detecting a second original combined voice acoustic signal and noise acoustic signal at a second transducer and generating a second electrical signal representing the second combined voice and noise signal;
processing the first original combined voice and noise signal and the second combined voice and noise signal to generate the noise correction signal; and
applying the noise correction signal and the original combined voice and noise signal to generate an enhanced voice and noise signal wherein a noise component of the enhanced voice and noise signal is substantially reduced and the signal-to-noise ratio of the voice component is improved.

14. The method in claim 13, wherein the first and second transducers comprises separate microphones.

15. The method in claim 15, wherein one of the microphones is positioned in use so as to primarily detect the speech of the user and the other one of the two microphones is positioned in use to detect primarily environmental noise.

16. The method in claim 12, wherein the step of processing of the first original combined voice and noise signal to generate a noise correction signal; and the step of applying the noise correction signal, are both performed using continuous time analog processing circuits.

17. The method in claim 15, wherein the step of processing of the first and second original combined voice and noise signal to generate a noise correction signal; and the step of applying the noise correction signal, are both performed using continuous time analog processing circuits.

18. The method in claim 12, further comprising processing the first original combined voice and noise signal with a discrete time processor to at least partially compensate or reduce noise present in the combined voice and noise signal before applying it so the noise correction signal to generate the enhanced voice and noise signal.

19. The method of claim 18, wherein the communications device is a telephone device for inputting a communication to a cellular telephone system.

20. The method of claim 12, wherein the enhanced voice and noise signal having reduced or cancelled noise is applied to the analog base-band or voice-band codec of a communications device.

21. The method in claim 12, wherein the signal to noise ratio of the voice is improved by at least 5 dB.

22. The method in claim 12, wherein the signal to noise ratio of the voice is improved by at least 10 dB.

23. The method in claim 12, wherein the signal to noise ratio of the voice is improved by at least 15 dB.

24. The method in claim 12, wherein the step of applying the noise correction signal and the original combined voice and noise signal to generate an enhanced voice and noise signal further comprises applying a gain to provide an amplification or an attenuation of at least one of the input or output signals.

25. The communications device of claim 6, wherein the continuous time quadrant multiplier is adapted to receive a gain signal or value to provide an amplification or an attenuation of at least one of the first multiplication input signals, second multiplication input signals, and multiplication output signals from the continuous time quadrant multiplier.

26. The communications device of claim 1, wherein the communications device is a wireless telephone.

27. The communications device of claim 1, further comprising a gain generating circuit for generating the gain signal or value to provide an amplification or an attenuation of at least one of the first multiplication input signals, second multiplication input signals, and multiplication output signals from the continuous time quadrant multiplier.
